(19) United States
(12) Patent Application Publication
(10) Pub. No.: US 2004/0129359 A1
(43) Pub. Date: Jul. 8, 2004

(54) Pneumatic tire

(76) Inventor: Hirotoshi Otsuki, Kobe-shi (JP)

Correspondence Address: BIRCH STEWART KOLASCH & BIRCH, PO BOX 747, FALLS CHURCH, VA, 22040-0747, US

(21) Appl. No.: 10/706,044

(22) Filed: Nov. 13, 2003

(30) Foreign Application Priority Data
Nov. 13, 2002 (JP) 2002-329684

(51) Int. Cl. B60C 1/00; C08K 3/34; B60C 11/00; B60C 11/01

(52) U.S. Cl. 152/209.16; 152/209.5; 524/492

(57) ABSTRACT

The present invention provides a pneumatic tire having a buttress in which ozone cracking resistance can be controlled over a long period and coloring and peeling do not occur, without compounding a large amount of an antioxidant. More specifically, the present invention relates to a pneumatic tire comprising a thin film layer of a width of 20 to 100 mm and a thickness of 0.5 to 5 mm formed on the buttress of the tire; wherein the thin film layer comprises a rubber composition containing 100 parts by weight of diene rubber and 0.5 to 10 parts by weight of a compound, which is in a solid state at a temperature of 40° C. or lower and is obtained by adsorbing N-(1-methylheptyl)-N′-phenyl-p-phenylenediamine to silica.

### BACKGROUND OF THE INVENTION

The present invention relates to a pneumatic tire, more specifically a pneumatic tire, which can maintain ozone cracking resistance of the buttress of the tire over a long period.

In recent years, along with the improvement in life span to abrasion of tires, particularly truck and bus tires, improvement is demanded in ozone cracking resistance in the buttress (part which is subject to compression strain due to load) located in the area ranging from the tire tread shoulder to the sidewall.

Conventionally, the method of placing a rubber composition in the form of tape, which is excellent in ozone resistance, on the tire sidewall buttress is known and in the method, butyl rubber (IIR (including halogenated IIR)) or ethylene-propylene-diene ternary copolymer rubber (EPDM), both of which are excellent in ozone cracking resistance, is commonly used. However, because adhesion between IIR or EPDM and diene rubber is relatively low, adhesion between the rubber composition in the form of tape and the sidewall may decrease under long term use. Also, the compounding costs become extremely high and practicability is poor.

Furthermore, known is the method of applying an amount of an ozone resistant antioxidant based on diene rubber in the rubber composition in the form of tape, which is larger than the amount in the sidewall areas. However, in such a method, because most ozone resistant antioxidants have polluting properties, when the amount is too large, the tape layer becomes brown and rises up and the problem of poor appearance occurs.

Also, in order to improve ozone cracking resistance of the sidewall, known are the method of adding a large amount of an ozone resistant antioxidant to a member, which is further inside than the surface of the tire buttress, and gradually filtering the antioxidant and the method of forming a sidewall of 2 layers and adding a large amount of the antioxidant in the lower layer (for example JP-B-7-64954). The method of adding a large amount of the antioxidant to the material of the tire interior is extremely effective. However, while the antioxidant filters out from the inside member toward the outside of the tire, the antioxidant also migrates further inward. Consequently, a considerable amount must be applied to obtain the effects and the compounding costs become extremely high.

### SUMMARY OF THE INVENTION

The present invention aims to provide a pneumatic tire having a buttress, in which ozone cracking resistance is maintained over a long period and discoloring and peeling do not occur, even when a large amount of an antioxidant is not applied.

As a result of intensive studies to solve the above problem, it was found that ozone cracking resistance is maintained over a long period and discoloring and peeling do not occur, by compounding a substance obtained by adsorbing a specific ozone resistant antioxidant to silica into the rubber composition. Thus the present invention was achieved.

That is, the present invention relates to a pneumatic tire comprising a thin film layer of a width of 20 to 100 mm and a thickness of 0.5 to 5 mm formed on the buttress of the tire; wherein the thin film layer comprises a diene rubber composition containing 100 parts by weight of diene rubber and 0.5 to 10 parts by weight of a compound, which is in a solid state at a temperature of 40° C. or lower and is obtained by adsorbing N-(1-methylheptyl)-N′-phenyl-p-phenylenediamine to silica.

The rubber composition preferably contains 0.3 to 1.5 parts by weight of sulfur based on 100 parts by weight of diene rubber.

The diene rubber preferably comprises 50 to 80% by weight of butadiene rubber and 20 to 40% by weight of natural rubber and/or isoprene rubber.

### BRIEF DESCRIPTION OF THE DRAWINGS

FIG. 1 is a partial cross sectional view depicting one embodiment of the pneumatic tire of the present invention.

### DETAILED DESCRIPTION

The present invention relates to a pneumatic tire, in which a thin film layer comprising a rubber composition containing diene rubber and a compound obtained by adsorbing a specific ozone resistant antioxidant to silica, is formed on the buttress of the tire.

In the present invention, the buttress refers to the area ranging from the tire tread shoulder to the sidewall, specifically the part from the non-grounding area of the tread shoulder to the point in the sidewall, which is the maximum tire width in the radial direction.

The diene rubber used in the thin film layer of the present invention is not particularly limited as long as the rubber is usually used in tires. Examples are natural rubber (NR), butadiene rubber (BR), isoprene rubber (IR) and styrene-butadiene rubber (SBR) and these may be used alone or in random combinations.

As the diene rubber, NR and/or IR and BR are preferably used in combination in view of balance in crack growth resistance and rubber strength properties. That is, the polymer system of the rubber composition used for the thin film layer of the present invention is preferably based on BR, which is excellent in ozone cracking resistance and crack growth resistance, rather than NR, but some NR must be used or else rubber strength properties and external scarring resistance decrease.

When the diene rubber contains BR, 50 to 80% by weight of BR is preferably included within the diene rubber and more preferably 55 to 70% by weight is included. When the content ratio of BR is less than 50% by weight, ozone cracking resistance and crack growth resistance tend to decrease. When the content ratio is more than 80% by weight, the breaking strength of rubber decreases and external scarring resistance tends to decrease.

When the diene rubber contains NR and/or IR, 20 to 40% by weight of NR and/or IR is preferably included within the diene rubber and more preferably 25 to 35% by weight is included. When the content ratio of NR and/or IR is less than 20% by weight, the breaking strength of rubber decreases and external scarring resistance tends to decrease. When the content ratio is more than 40% by weight, ozone cracking resistance tends to decrease.

In the compound obtained by adsorbing a specific antioxidant to silica which is used in the thin film layer of the present invention, N-(1-methylheptyl)-N′-phenyl-p-phenylenediamine (8PPD), which has a larger molecular weight than commonly used ozone resistant antioxidants such as N-isopropyl-N′-phenyl-p-phenylenediamine (IPPD) and N-1,3-dimethylbutyl-N′-phenyl-p-phenylenediamine (6PPD) and is hardly volatile and outflowing from the rubber compound, is used as the specific antioxidant.

In the present invention, the rubber composition comprising diene rubber and 8PPD-absorbed silica compound in which 8PPD is absorbed to silica is applied as the rubber composition in the form of tape, which is placed on the tire buttress and requires ozone cracking resistance. By absorbing 8PPD to silica, migration and outflowing of 8PPD from the rubber compound becomes slow and so ozone cracking resistance can be maintained over a long period.

The method for absorbing 8PPD to silica in the 8PPD-absorbed silica compound is not particularly limited but preferably, in order to prevent the antioxidant from decomposing by heat, mixing is conducted at 50° C. or lower. As the method for mixing, silica can be added while stirring the antioxidant or in the case that the amount of silica is large, silica can be coated with the antioxidant and then stirred.

The type of silica is not particularly limited as long as 8PPD can be absorbed. Examples are VN3 (product name) available from Degussa Co., Z195Gr (product name) available from Rhodia Ltd., Nipsil AQ (product name) available from Nippon Silica Co., Ltd. and Carplex RB (product name) available from Shionogi & Co., Ltd., which have strong absorption.

The above silica preferably has a cetyl trimethyl ammonium bromide (CTAB) absorption amount of 70 to 250 m²/g. When the CTAB absorption amount of the silica is less than 70 m²/g, migration and outflowing of 8PPD from the rubber compound tends to become fast. When the CTAB absorption amount of the silica is less than 250 m²/g, migration of the absorbed antioxidant tends to become too slow.

The proportion of silica in the 8PPD-absorbed silica compound is preferably 20 to 80% by weight within the compound, more preferably 30 to 50% by weight. When the proportion of silica in the compound is less than 20% by weight, the absorption effect of silica may not be sufficiently obtained. On the other hand, when the proportion of silica in the compound is more than 80% by weight, the absorption effect of silica becomes too strong and migration of the antioxidant tends to become too slow.

The amount of the 8PPD-absorbed silica compound used in the present invention is 0.5 to 10 parts by weight, preferably 3 to 7 parts by weight, based on 100 parts by weight of diene rubber. An amount of less than 0.5 part by weight of the 8PPD-absorbed silica compound is ineffective and when the amount is more than 10 parts by weight, the tire appearance becomes poor.

The compound obtained by absorbing antioxidant 8PPD to silica must be in a solid state at a temperature of 40° C. or lower. For the compound to be in a solid state at a temperature of 40° C. or lower, the amount of the absorbing silica in the compound must be sufficient. When the amount of silica is small and a solid state in a temperature of at most 40° C. cannot be maintained, the effects obtained by absorbing 8PPD are insufficient.

To the rubber composition used for the thin film layer of the present invention, besides diene rubber and the compound obtained by absorbing antioxidant 8PPD to silica, additives which are usually added to a rubber composition such as carbon black, zinc oxide, stearic acid, aroma oil, sulfur and a vulcanization accelerator may be added accordingly.

The type of carbon black added to the rubber composition is not particularly limited and examples are HAF, ISAF, SAF, GPF and FEF.

The amount of carbon black is preferably 20 to 80 parts by weight based on 100 parts by weight of diene rubber. When the amount of carbon black is less than 20 parts by weight, the breaking strength of the rubber decreases and as a result, external scarring resistance tends to decrease. When the amount of carbon black is more than 80 parts by weight, crack growth resistance tends to decrease.

The amount of sulfur added to the rubber composition is preferably 0.3 to 1.5 parts by weight based on 100 parts by weight of diene rubber, as sulfur which is excellent in heat resistance is compounded in a small amount. When the amount of sulfur is less than 0.3 part by weight, the crosslinking density becomes too low that obtaining sufficient rubber strength becomes difficult and external scarring resistance tends to decrease. On the other hand, when the amount of sulfur is more than 1.5 parts by weight, rubber hardness when heat aging becomes large and surface strain of the rubber increases. As a result, ozone cracking tends to easily develop.

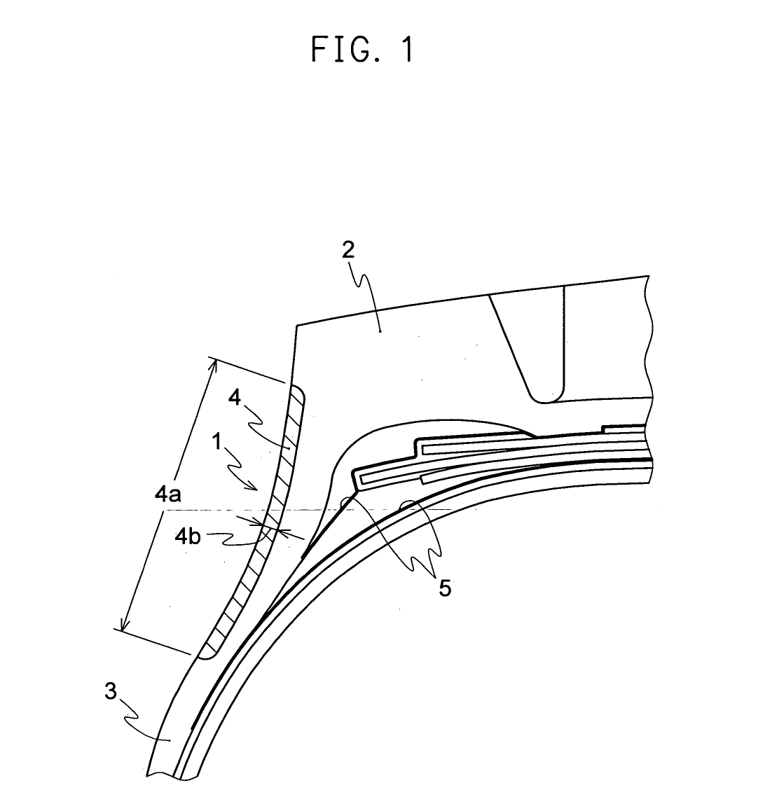

In the pneumatic tire of the present invention, a thin film layer comprising the above rubber composition is formed on the buttress of the tire. In FIG. 1, one embodiment of the present invention is depicted.

As shown in FIG. 1, buttress 1 is located in the area ranging from tread shoulder 2 to sidewall 3. In FIG. 1, thin film layer 4 is formed on the surface of buttress 1. FIG. 1 is an example of a tire having a structure with band 5 inside the tire.

In the pneumatic tire of the present invention, thin film layer 4 can be located on the surface of buttress 1 or the buttress layer can have a 2 layer structure and the thin film layer can be formed on the outer layer.

In the present invention, the thin film layer formed on the buttress must have width 4a, shown in FIG. 1, of 20 to 100 mm, preferably 30 to 80 mm. When width 4a of the thin film layer is less than 20 mm, sufficiently covering the area in which cracks develop may not be possible. When width 4a of the thin film layer is more than 100 mm, the end of the thin film layer on the tire rim side may peel off due to flexing fatigue of the tire.

In the present invention, the thin film layer formed on the buttress must have thickness 4b, shown in FIG. 1, of 0.5 to 5 mm, preferably 1 to 3 mm. When thickness 4b of the thin film layer is less than 0.5 mm, sufficient ozone cracking resistance may not be obtained. When thickness 4b of the thin film layer is more than 5 mm, in the case that abrasion due to grounding occurs until the end of the tire lifespan, partial abrasion of the tire shoulder tends to be promoted.

The rubber composition composing the thin film layer of the present invention is obtained by kneading diene rubber, the 8PPD-absorbed silica compound and other components using a usual processing device such as a roll, Banbury mixer or kneader.

The pneumatic tire of the present invention is prepared by using the thin film layer for the buttress of the tire, by the usual method. That is, the rubber composition in an unvulcanized state can be extruded in the form of a buttress and laminated by the usual method on a tire forming machine to form an unvulcanized tire or can be extruded together with the sidewall in the extrusion step. The unvulcanized tire is heated and pressurized under normal conditions in a vulcanizer to obtain a vulcanized tire. In the pneumatic tire obtained in this way, ozone cracking resistance in the buttress is superior than in the diene rubber composition which forms the sidewall and so ozone cracking resistance of the buttress can be maintained over long term use.

Hereinafter, the present invention is explained in detail by means of Examples and Comparative Examples, but the present invention is not limited thereto.

The materials used in Examples and Comparative Examples are described below.

NR: RSS #3

BR: BR1220 available from Zeon Corporation

Carbon black: Carbon N330 available from Showa Cabot Co. Ltd.

Antioxidant A: Antigene 3C (N-isopropyl-N′-phenyl-p-phenylenediamine, molecular weight: 226.3) available from Sumitomo Chemical Co., Ltd.

Antioxidant B: Antigene 6C (N-1,3-dimethylbutyl-N′-phenyl-p-phenylenediamine, molecular weight: 268.4) available from Sumitomo Chemical Co., Ltd.

Antioxidant C: Antioxidant 35 (N-(1-methylheptyl)-N′-phenyl-p-phenylenediamine, molecular weight: 296.4) available from Seiko Chemical Co., Ltd.

Antioxidant D: Antioxidant 35-PR (mixture of antioxidant C and silica, in a solid state at 40° C. or lower, proportion of silica: approximately 33% by weight, CTAB absorption amount of silica: 165m²/g) available from Seiko Chemical Co., Ltd.

Aroma oil: Process XN-14D available from Japan Energy Corporation

Sulfur: fine powder sulfur 200 mesh available from Tsurumi Chemicals Co., Ltd.

Vulcanization Accelerator NS: Nocceler NS (N-tert-butyl-2-benzothiazylsufenamide), available from Ouchi Shinko Chemical Industrial Co., Ltd.

### EXAMPLES 1 to 5 AND COMPARATIVE EXAMPLES 1 to 9

<Process for Preparing Rubber Composition>

The materials shown in Table 1 according to the composition shown in Table 1 were mixed in a 1.8 L Banbury mixer to obtain each unvulcanized sample rubber composition. Then, each rubber composition formed in a thickness of 2 mm was vulcanized for 30 minutes at 150° C. to obtain a vulcanized rubber composition. The obtained vulcanized rubber compositions were subjected to the rubber hardness and tensile tests described below and respectively evaluated. The results are shown in Table 1.

(Rubber Hardness (Hs))

The rubber hardness (Hs) at 23° C. was measured with a durometer type A according to JIS K6253. The time of measurement was after preparation of the unvulcanized rubber composition and after aging under conditions of 100° C. for 72 hours. The hardness was measured with 3 vulcanized rubber boards piled up.

(Tensile Test)

The tensile test was conducted at 23° C. with a dumbbell 3 type sample according to JIS K6251. By this test, modulus at 200% elongation M200 (MPa), stress at break TB (MPa) and elongation at break EB (%) of the vulcanized rubber composition were respectively measured.

In order to achieve external scarring resistance, EB must be at least 500%.

<Preparation of Pneumatic Tire>

Each unvulcanized rubber composition in the form of tape was laminated as the thin film layer (width 50 to 70 mm, thickness 2 to 3.5 mm) to the buttress of a 295/75R 22.5 size unvulcanized tire for trucks and buses and then vulcanized. More specifically, the tire was prepared by the divisional method, in which the standard sidewall rubber in the form of tape and two kinds of the unvulcanized rubber composition were laminated on one unvulcanized tire. Using each obtained vulcanized tire, evaluation of ozone cracking resistance and coloring resistance described below were conducted. The results are shown in Table 1.

(Ozone Cracking Resistance)

The tire was recovered after 1.5 years of actual running in the USA market and the ozone cracking state of the buttress was evaluated in 5 steps according to the following criteria. 4 or higher is acceptable. In the case of an evaluation between steps, for example when the part in which the size of ozone cracking corresponds to evaluation 3 and the part in which the size of ozone cracking corresponds to evaluation 4 are approximately half each, the tire is evaluated as “3.5”.

5: Ozone cracking is not developed or cannot been seen unless magnified with a 10 times magnifying glass.

4: Size of ozone cracking is at most 1 mm.

3: Size of ozone cracking is 1 to 3 mm.

2: Size of ozone cracking is at least 3 mm.

1: Size of ozone cracking is at least 3 mm and depth is at least 2 mm.

(Coloring Resistance)

The degree of coloring in rubber of the buttress and rubber of the sidewall in an early stage (within 3 months) of actual running was evaluated in 3 steps according to the following criteria. From Δ to X, brown coloring of the rubber becomes stronger and the tape area rises up to look strange, causing problems in appearance.

◯: Difference in color of sidewall rubber and tape area cannot be clearly differentiated by the naked eye.

Δ: Tape area is colored brown but the boundary cannot be seen at a distance of 3 m from the tire.

X: Brown coloring of tape area is strong and the boundary can be seen at a distance of 3 m from the tire.

TABLE 1

| | Ex. | | | | | Com. Ex. | | | | | | | | |
|---|---|---|---|---|---|---|---|---|---|---|---|---|---|---|
| | 1 | 2 | 3 | 4 | 5 | 1 | 2 | 3 | 4 | 5 | 6 | 7 | 8 | 9 |
| Composition | | | | | | | | | | | | | | |
| (parts by weight) | | | | | | | | | | | | | | |
| NR | 35 | 35 | 15 | 40 | 35 | 60 | 60 | 60 | 35 | 35 | 35 | 35 | 35 | 35 |
| BR | 65 | 65 | 85 | 60 | 65 | 40 | 40 | 40 | 65 | 65 | 65 | 65 | 65 | 65 |
| Carbon Black | 50 | 50 | 50 | 50 | 50 | 50 | 50 | 50 | 50 | 50 | 50 | 50 | 50 | 50 |
| Zinc Oxide | 3 | 3 | 3 | 3 | 3 | 3 | 3 | 3 | 3 | 3 | 3 | 3 | 3 | 3 |
| Stearic Acid | 2 | 2 | 2 | 2 | 2 | 2 | 2 | 2 | 2 | 2 | 2 | 2 | 2 | 2 |
| Antioxidant A | 0 | 0 | 0 | 0 | 0 | 0 | 4 | 0 | 0 | 0 | 0 | 0 | 0 | 0 |
| Antioxidant B | 2 | 0 | 2 | 2 | 2 | 4 | 0 | 8 | 4 | 4 | 2 | 0 | 2 | 2 |
| Antioxidant C | 0 | 0 | 0 | 0 | 0 | 0 | 0 | 0 | 0 | 0 | 2 | 4 | 0 | 0 |
| Antioxidant D | 3 | 6 | 3 | 3 | 3 | 0 | 0 | 0 | 0 | 0 | 0 | 0 | 0.4 | 11 |
| Aroma Oil | 5 | 5 | 5 | 5 | 5 | 5 | 5 | 5 | 5 | 5 | 5 | 5 | 5 | 5 |
| Sulfur | 1 | 1 | 1 | 1 | 1.6 | 1.6 | 1.6 | 1.6 | 1.6 | 1 | 1 | 1 | 1 | 1 |
| Vulcanization | 1.5 | 1.5 | 1.5 | 1.5 | 0.7 | 0.7 | 0.7 | 0.7 | 0.7 | 1.5 | 1.5 | 1.5 | 1.5 | 1.5 |
| Accelerator NS | | | | | | | | | | | | | | |
| Properties | | | | | | | | | | | | | | |
| Hs | 55 | 56 | 53 | 55 | 54 | 55 | 55 | 54 | 54 | 54 | 54 | 55 | 55 | 49 |
| Hs after Aging | 59 | 60 | 58 | 59 | 63 | 65 | 66 | 63 | 64 | 59 | 58 | 60 | 61 | 52 |
| Modulus 200% | 5.4 | 5.5 | 4 | 5.2 | 4.9 | 5 | 5.2 | 4.8 | 4.5 | 4.9 | 5 | 5.3 | 4.7 | 3 |
| (MPa) | | | | | | | | | | | | | | |
| TB (MPa) | 18.1 | 18.8 | 15.6 | 19 | 18 | 18.5 | 18.8 | 18.9 | 17.3 | 18.9 | 18.3 | 18 | 18.1 | 19 |
| EB (%) | 550 | 570 | 460 | 570 | 560 | 580 | 570 | 620 | 550 | 530 | 540 | 530 | 530 | 680 |
| Ozone Cracking | 4 | 4.5 | 4.5 | 4.5 | 4 | 1.5 | 1 | 3.5 | 2 | 2.5 | 3 | 3.5 | 3.5 | 5 |
| Resistance | | | | | | | | | | | | | | |
| Coloring | ◯ | ◯ | ◯ | ◯ | ◯ | ◯ | Δ | X | ◯ | ◯ | ◯ | ◯ | ◯ | Δ |
| Resistance | | | | | | | | | | | | | | |

As evident from the properties shown in Table 1, in Examples 1 to 5 in which the thin film layer of claim 1 is formed on the buttress of the pneumatic tire, ozone cracking resistance is maintained and excellent results are obtained regarding coloring resistance.

On the other hand, in Comparative Examples 1 to 7 in which the compound obtained by absorbing a specific antioxidant to silica is not included in the thin film layer and Comparative Example 8 in which the amount of the compound was less than 0.5 part by weight based on 100 parts of diene rubber, ozone cracking resistance was poor.

Also, in Comparative Example 10 in which the amount of the compound was more than 10 parts by weight based on 100 parts of diene rubber, although ozone cracking resistance was excellent, coloring resistance was inferior.

According to the present invention, development of ozone cracking in the buttress can be controlled over a long period without compounding a large amount of an antioxidant. Also, coloring resistance is excellent over a long period.

Particularly, in recent years, life span to abrasion of truck and bus tires is improved and the duration of use is becoming longer and so in the phase of secondary retreading, the ozone cracking level of the buttress tends to decrease. By employing the present invention, such problems can be solved.

What is claimed is:

1. A pneumatic tire comprising a thin film layer of a width of 20 to 100 mm and a thickness of 0.5 to 5 mm formed on the buttress of said tire;
wherein said thin film layer comprises a rubber composition containing 100 parts by weight of diene rubber and 0.5 to 10 parts by weight of a compound, which is in a solid state at a temperature of 40° C. or lower and is obtained by adsorbing N-(1-methylheptyl)-N′-phenyl-p-phenylenediamine to silica.

2. The pneumatic tire of claim 1, wherein said rubber composition contains 0.3 to 1.5 parts by weight of sulfur based on 100 parts by weight of diene rubber.

3. The pneumatic tire of claim 1 or 2, wherein said diene rubber comprises 50 to 80% by weight of butadiene rubber and 20 to 40% by weight of natural rubber and/or isoprene rubber.
